(19) United States
(12) Patent Application Publication
(10) Pub. No.: US 2019/0061750 A1
(43) Pub. Date: Feb. 28, 2019

(54) COLLISION MITIGATION CONTROL DEVICE

(71) Applicant: DENSO CORPORATION, Kariya-city, Aichi-pref. (JP)

(72) Inventors: Kei TAMURA, Kariya-city, Aichi-pref. (JP); Yosuke ITO, Kariya-city, Aichi-pref. (JP)

(21) Appl. No.: 16/080,459

(22) PCT Filed: Feb. 13, 2017
(86) PCT No.: PCT/JP2017/005150

§ 371 Date: Aug. 28, 2018

(30) Foreign Application Priority Data
Mar. 4, 2016 (JP) 2016-041833

(51) Int. Cl. B60W 30/095; B60W 50/00; B60W 30/09

(52) U.S. Cl. CPC B60W 30/0956; B60W 50/0097; B60W 50/0098; B60W 30/09; G08G 1/166; B60W 2050/0095; B60W 2550/10; B60W 2520/06; B60W 2520/10; B60W 2050/0089

(57) ABSTRACT

A control device controls a collision mitigation operation of a collision mitigation device applied to a vehicle. The control device includes: a determination unit that determines the probability of a collision between the vehicle and an object on the basis of the position of the object detected by a detection device and a history of positions of the object; an execution unit that causes the collision mitigation device to execute the collision mitigation operation in response to determining that the probability of a collision is higher than a predetermined value; and a condition changing unit that executes, in response to determining that the detected object is a pedestrian or bicycle emerging rapidly from behind a stationary object, a condition changing process for making a change such that the determination unit determines the probability of a collision without using the history of positions of the object.

### CROSS-REFERENCE TO RELATED APPLICATION

The present application is based on Japanese Patent Application No. 2016-041833 filed on Mar. 4, 2016, the contents of which are incorporated herein by reference.

### TECHNICAL FIELD

The present disclosure relates to a control device that controls collision mitigation operation for a vehicle and an object.

### BACKGROUND ART

Some conventional collision mitigation control devices of this type extend a path connecting past positions of an object relative to a vehicle and determine the probability of a collision using the point of intersection between the path and the vehicle as a collision position (refer to PTL 1).

### CITATION LIST

### Patent Literature

[PTL 1] JP 2014-213777 A

### SUMMARY OF THE INVENTION

However, since the collision mitigation control device described in PTL 1 requires a plurality of past positions (history of positions) of an object for obtaining the path of the object, it may take time to complete determination of the probability of a collision. Especially when a pedestrian or bicycle is emerging rapidly from behind a stationary object, the vehicle's collision mitigation operation needs to be executed early since little time is left before the pedestrian or bicycle collides with the vehicle.

The present disclosure has been made in view of such circumstances, and the main object thereof is to provide a collision mitigation control device capable of preventing unnecessary execution of collision mitigation operation and executing collision mitigation operation against unexpected objects early.

The present disclosure employs the following means in order to solve the above-mentioned problems.

A first means is a control device that is applied to a vehicle including a detection device that detects the position of an object located ahead of the vehicle and a collision mitigation device that executes collision mitigation operation for the vehicle and the object, the control device being configured to control the collision mitigation operation of the collision mitigation device, the control device including: a determination unit that determines the probability of a collision between the vehicle and the object on the basis of the position of the object detected by the detection device and a history of positions of the object; an execution unit that causes the collision mitigation device to execute the collision mitigation operation in response to the determination unit determining that the probability of a collision is higher than a predetermined value; and a condition changing unit that executes, in response to determining that the object detected by the detection device is a pedestrian or bicycle emerging rapidly from behind a stationary object, a condition changing process for making a change such that the determination unit determines the probability of a collision without using the history of positions of the object detected by the detection device.

According to the above configuration, the position of the object located ahead of the vehicle is detected by the detection device. The probability of a collision between the vehicle and the object is determined by the determination unit on the basis of the position of the object detected by the detection device and the history of positions of the object. Then, the collision mitigation operation for the vehicle and the object is executed by the collision mitigation device in response to the determination unit determining that the probability of a collision is higher than a predetermined value.

Here, the condition changing unit executes, in response to determining that the object detected by the detection device is a pedestrian or bicycle suddenly emerging from behind a stationary object, the condition changing process for making a change such that the determination unit determines the probability of a collision without using the history of positions of the object detected by the detection device. Consequently, the need to use the history of positions of the object is fundamentally eliminated, and thus the probability of a collision between the vehicle and the object can be determined rapidly. As a result, the vehicle's collision mitigation operation against sudden appearance of the pedestrian or bicycle can be executed early. Under normal conditions, the probability of a collision between the vehicle and the object is determined on the basis of the position of the object and the history of positions of the object, so that unnecessary execution of collision mitigation operation can be prevented.

Note that the collision mitigation device includes a braking device that brakes the vehicle, a steering device that steers the vehicle, an alarm device that sets off an alarm, and the like. The collision mitigation operation of the braking device includes not only the operation of actually reducing the speed of the vehicle but also preliminary operation (what is called brake prefill/pre-brake operation) for decreasing the speed of the vehicle.

A second means is a control device that is applied to a vehicle including a detection device that detects the position of an object located ahead of the vehicle and a collision mitigation device that executes collision mitigation operation for the vehicle and the object, the control device being configured to control the collision mitigation operation of the collision mitigation device, the control device including: a determination unit that determines the probability of a collision between the vehicle and the object on the basis of the position of the object detected by the detection device and a history of positions of the object; an execution unit that causes the collision mitigation device to execute the collision mitigation operation in response to the determination unit determining that the probability of a collision is higher than a predetermined value; and a condition changing unit that executes, in response to determining that the object detected by the detection device is a pedestrian or bicycle emerging rapidly from behind a stationary object, a condition changing process for reducing an amount of history data used for the determination by the determination unit.

According to the above configuration, the condition changing unit executes, in response to determining that the object detected by the detection device is a pedestrian or bicycle suddenly emerging from behind a stationary object, the condition changing process for reducing the amount of the history data used for the determination by the determination unit. Therefore, the probability of a collision is determined using a smaller amount of position history than before the change in condition, which can reduce the time required for completion of the determination. As a result, the vehicle's collision mitigation operation against sudden appearance of the pedestrian or bicycle can be executed early.

### BRIEF DESCRIPTION OF DRAWINGS

The above and other objects, characteristics, and advantages of the present disclosure will be further clarified in the following detailed description with reference to the accompanying drawings, in which:

FIG. 1 is a block diagram schematically illustrating a pre-crash safety system;

FIG. 2 is a flowchart illustrating a process of collision mitigation control;

FIG. 3 is a bird's-eye diagram illustrating a collision lateral position;

FIG. 4 is a schematic diagram illustrating a method of calculating collision probability;

FIG. 5 is a bird's-eye diagram illustrating a pedestrian suddenly emerging from behind a vehicle;

FIG. 6 is a flowchart illustrating a process of calculating the amount of correction with collision probability and collision width;

FIG. 7 is a bird's-eye diagram illustrating collision width; and

FIG. 8 is a flowchart illustrating a process of calculating the amount of correction with a hidden pedestrian.

### DESCRIPTION OF EMBODIMENTS

Hereinafter, an embodiment of a pre-crash safety system (hereinafter referred to as the “PCS”) mounted in a vehicle will be described with reference to the drawings. The PCS is a system that detects a possible collision between the vehicle and an object to prevent a vehicle collision or mitigate damage from a vehicle collision.

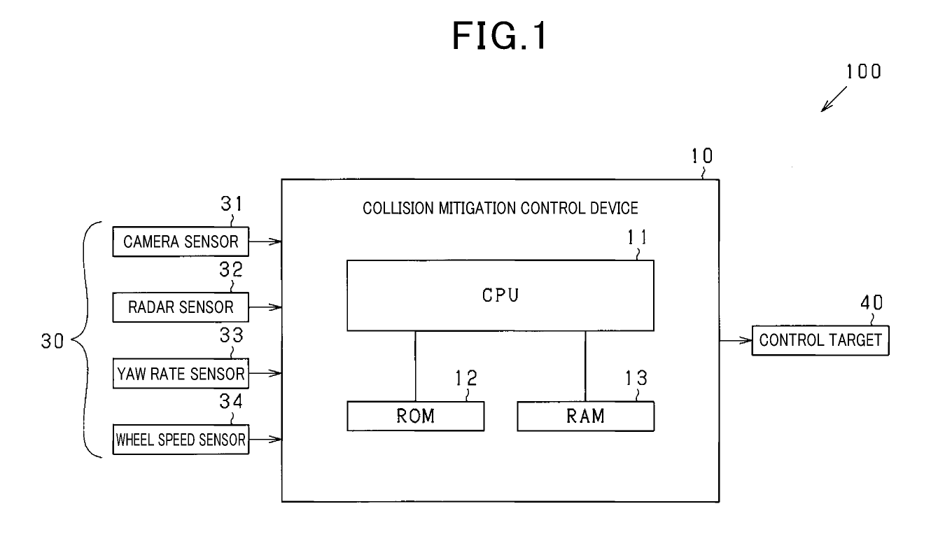

As illustrated in FIG. 1, the PCS 100 includes a collision mitigation control device 10, various sensors 30, and a control target 40.

The various sensors 30 include, for example, a camera sensor 31, a radar sensor 32, a yaw rate sensor 33, a wheel speed sensor 34, and the like. The camera sensor 31 (corresponding to a detection device) is configured as a stereo camera capable of detecting the distance to an object, for example, and recognizes, on the basis of a captured image, the shape of and distance to an object in the image such as a pedestrian, a road obstruction, and another vehicle.

The radar sensor 32 (corresponding to a detection device) detects an object and the position thereof (position relative to the host vehicle). The yaw rate sensor 33 is a well-known yaw rate sensor that detects the turning angular velocity of the vehicle.

The wheel speed sensor 34 detects the rotational speed the wheels, that is, the speed of the vehicle. The results of detection by the various sensors 30 are acquired by the collision mitigation control device 10.

Note that the camera sensor 31 and the radar sensor 32 detect objects located in the traveling direction of the vehicle at predetermined cycles set in advance (for example, at intervals of 100 ms). The radar sensor 32 emits directional electromagnetic waves to an object, and receives reflected waves to detect the shape and size of the object.

The collision mitigation control device 10 is a well-known microcomputer including a CPU 11, ROM 12, RAM 13, and the like. The collision mitigation control device 10 executes a program stored in the ROM 12 on the basis of the results of detection by the various sensors 30, for example, to execute various types of control such as collision mitigation control that will be described later.

The collision mitigation control device 10 executes such control to activate the control target 40 in accordance with the result of control. Note that examples of the control target 40 (corresponding to a collision mitigation device) include a brake (corresponding to a braking device), a steering (corresponding to a steering device), an actuator (corresponding to an impact reduction device) that drives a seat belt or the like, an alarm device that sets off an alarm, and the like. The following description of the present embodiment is based on the assumption that the control target 40 is a brake and that an object targeted for collision mitigation is a pedestrian.

When the CPU 11 executes the function of automatic braking as described above, the control target 40 is activated such that a preset deceleration and a preset deceleration amount (difference between the speed before activation of automatic braking and the speed after activation of automatic braking) are achieved in accordance with a detection signal from the wheel speed sensor 34.

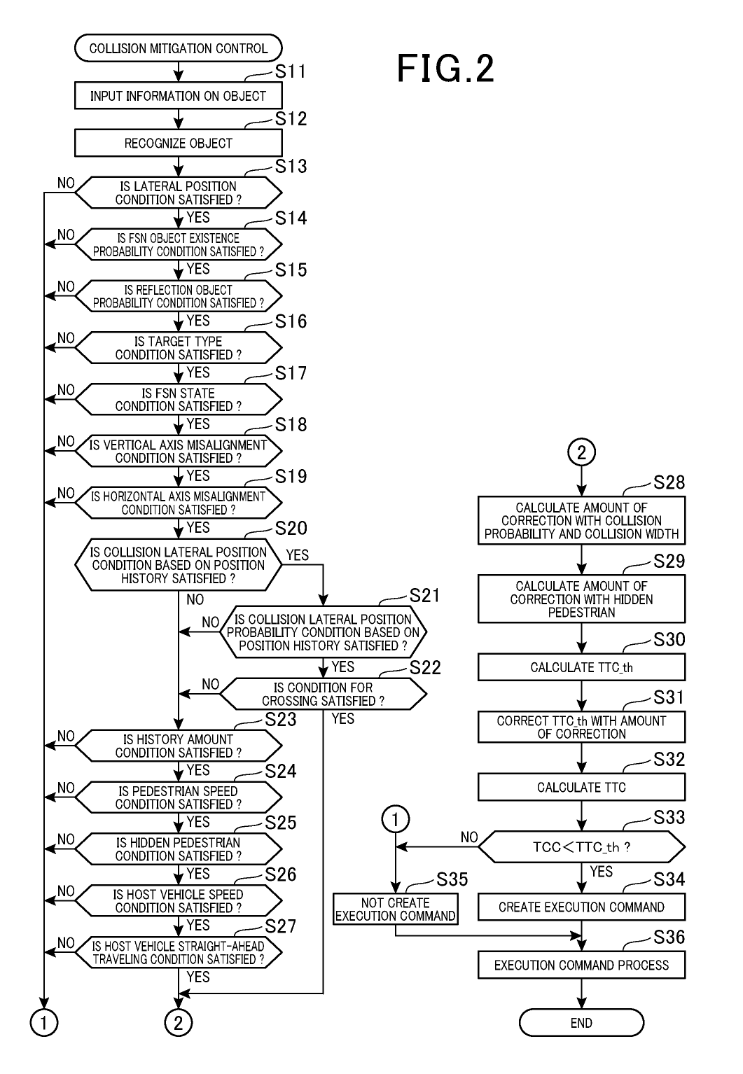

Next, the collision mitigation control that is a process for executing automatic braking will be described with reference to the flowchart of FIG. 2. The series of steps is repeatedly executed by the collision mitigation control device 10 at predetermined cycles (for example, at intervals of about 50 ms).

First, information on an object is input (S11). Specifically, information on the position of the latest object detected by the camera sensor 31 and the radar sensor 32 is acquired. Then, on the basis of a radar detected position that is the position of the object detected by the radar sensor 32 and a camera detected position that is the position of the object detected by the camera sensor 31, an FSN position (fusion position) is calculated through a comprehensive evaluation of these positions.

Next, the object is recognized (S12). Specifically, the type of the object (vehicle, pedestrian, bicycle, motorcycle, or the like) is recognized in accordance with, for example, the shape of the object obtained by the camera sensor 31 (using pattern matching or the like). Then, objects previously recorded in the RAM 13 or the like are correlated with the currently recognized object. The behavior of each object, the positional relation with respect to each object (coordinates of the object relative to the host vehicle), and the velocity relative to each object are also recognized.

Next, it is determined whether conditions for activating the brake are satisfied (S13 to S19). These determinations in S13 to S19 do not use the history of positions detected by the radar sensor 32 and the camera sensor 31.

Specifically, it is determined whether the condition relating to the lateral position of the object is satisfied (S13). More specifically, it is determined whether the lateral position of the object relative to the host vehicle overlaps with the width range of the host vehicle. This determination of the lateral position condition is executed using each of the radar detected position and the FSN position.

If it is determined in the determination with the two positions that the condition relating to the lateral position of the object is satisfied (S13: YES), it is determined whether the condition relating to FSN object existence probability (fusion object existence probability) is satisfied (S14). More specifically, the FSN object existence probability becomes higher when an object is detected by the radar sensor 32, and the FSN object existence probability becomes lower when no object is detected by the radar sensor 32. That is, an FSN object existence probability is increased when an object is detected by the radar sensor 32, and the FSN object existence probability is decreased when no object is detected by the radar sensor 32. Then, it is determined whether the FSN object existence probability is higher than a threshold value.

If it is determined that the condition relating to FSN object existence probability is satisfied (S14: YES), it is determined whether the condition relating to reflection object probability is satisfied (S15). More specifically, the reflection object probability becomes higher when the detection of the object by the radar sensor 32 is based on reflected waves from an object with which the vehicle is not likely to collide. That is, a reflection object probability is increased when the detection of the object by the radar sensor 32 is based on reflected waves from an object with which the vehicle is not likely to collide. Then, it is determined whether the reflection object probability is lower than a threshold value.

If it is determined that the condition relating to reflection object probability is satisfied (S15: YES), it is determined whether the condition relating to the type of target is satisfied (S16). More specifically, it is determined whether the type of target recognized by the camera sensor 31 is an object targeted for collision determination, such as a vehicle, a pedestrian, a bicycle, or a motorcycle.

If it is determined that the condition relating to the type of target is satisfied (S16: YES), it is determined whether the condition relating to an FSN state (fusion state) is satisfied (S17). More specifically, it is determined whether an FSN state is established, that is, whether it is determined that the object detected by the radar sensor 32 and the object detected by the camera sensor 31 are the same.

If it is determined that the condition relating to an FSN state is satisfied (S17: YES), it is determined whether the condition relating to vertical axis misalignment is satisfied (S18). More specifically, it is determined whether the vertical axis direction (up-down direction) of the radar sensor 32 is aligned correctly.

If it is determined that the condition relating to vertical axis misalignment is satisfied (S18: YES), it is determined whether the condition relating to horizontal axis misalignment is satisfied (S19). More specifically, it is determined whether the horizontal axis direction (right-left direction) of the radar sensor 32 is aligned correctly.

If it is determined that the condition relating to horizontal axis misalignment is satisfied (S19: YES), it is determined whether conditions for activating the brake are satisfied on the basis of the history of positions detected by the radar sensor 32 and the camera sensor 31 (S20 to S22). Note that in a case where the accumulated amount of history data of positions does not reach the amount required for determination, it is determined that the conditions are not satisfied.

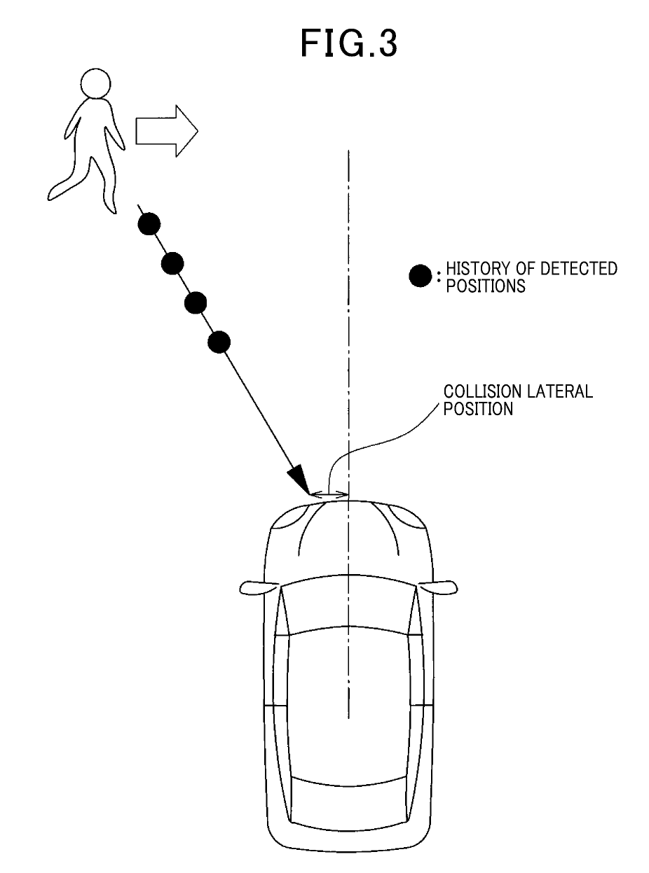

Specifically, it is determined whether the condition relating to a collision lateral position based on position history is satisfied (S20). More specifically, the collision lateral position of the object is calculated. The collision lateral position indicates, as illustrated in FIG. 3, the distance from the center of the width direction of the host vehicle to the position (collision position) at which the object is predicted to collide with the host vehicle (for example, positive and negative values respectively represent the left and right sides relative to the center). A path (path approximated with the method of least squares or the like) connecting relative positions of the object is extended, and the point of intersection between the path and the vehicle (front face of the host vehicle) is estimated as a collision position. Then, it is determined whether the collision lateral position is within the width range of the host vehicle. This determination of the collision lateral position condition is executed using each of the radar detected position and the FSN position.

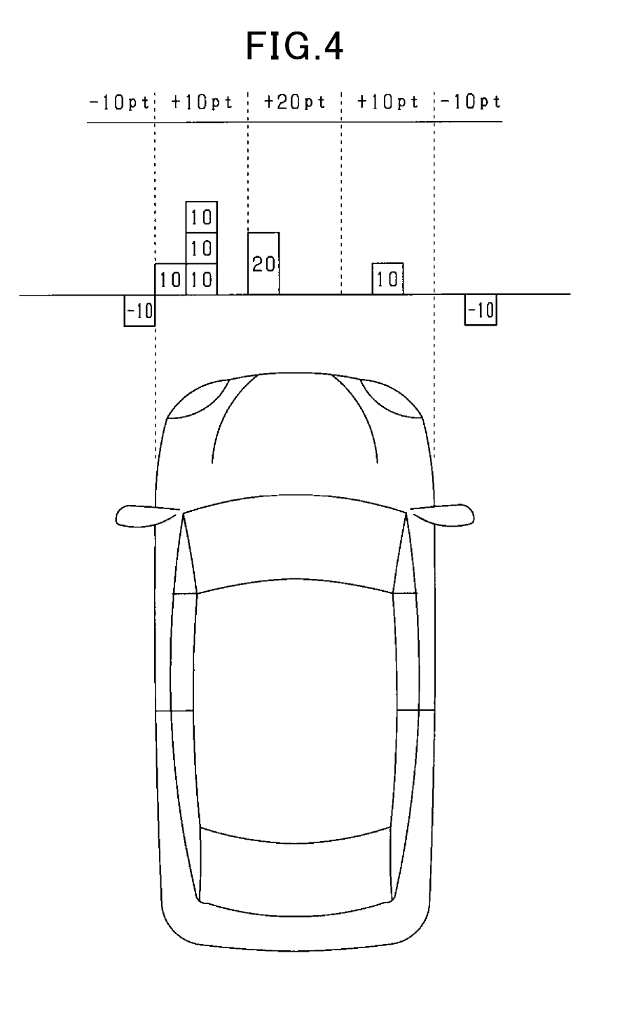

If it is determined in the determination with the two positions that the condition relating to a collision lateral position based on position history is satisfied (S20: YES), it is determined whether the condition relating to collision lateral position probability based on position history is satisfied (S21). Specifically, the collision probability representing the probability of a collision between the host vehicle and the object is calculated. The collision probability (collision rate) is calculated by employing the method, that is, by adding up points (scores) set in advance for the above-mentioned collision lateral positions every time the process is performed. More specifically, as illustrated in FIG. 4, a plurality of collision position regions is defined in advance, and points are correlated with the respective regions. To be more specific, higher points are correlated with collision position regions closer to the width-directional center of the vehicle (in other words, higher points are correlated with collision lateral positions having smaller absolute values).

In the example illustrated in FIG. 4, five collision position regions are defined, and 20, 10, and −10 points are respectively correlated with the region around the width-directional center of the vehicle, right and left regions adjacent to the central region, and right and left regions outside the width of the vehicle. For example, if the collision position in the first process is within the region correlated with 20 points, 20 points are added and then multiplied by a predetermined coefficient (e.g., one), whereby a collision probability of 20% is obtained. Next, if the collision position in the second process is within the region correlated with 10 points, 10 points are added, and a collision probability of 30% is obtained. If the collision position in the third process is within the region correlated with −10 points, 10 points are subtracted, and a collision probability of 20% is obtained. Then, it is determined whether the collision probability is higher than a threshold value. This determination of the condition relating to collision lateral position probability is executed using each of the radar detected position and the FSN position.

If it is determined in the determination with the two positions that the condition relating to collision lateral position probability based on position history is satisfied (S21: YES), it is determined whether the condition for crossing is satisfied (S22). More specifically, it is determined whether the lateral velocity of the object calculated on the basis of the FSN position is higher than a threshold value. With this threshold value, it can be determined that the object is moving in the lateral direction with respect to the traveling direction of the host vehicle.

If it is determined that the condition for crossing is satisfied (S22: YES), steps S28 to 34 are executed. Specifically, if all the conditions in S13 to S22 are satisfied (if the probability of a collision is higher than a predetermined value), an automatic braking execution command for causing the brake to execute collision mitigation operation is created on the basis of a collision time TTC representing the time left before the host vehicle collides with the object.

In contrast, if it is determined that any of the conditions in steps S13 to S19 is not satisfied, an automatic braking execution command is not created (S35).

If it is determined that any of the conditions in steps S20 to S22 (determinations of the conditions based on position history) is not satisfied, it is determined whether the detected object is a pedestrian emerging (pedestrian jumping out) rapidly from behind a stationary object (S23 to 25).

Specifically, it is determined whether the condition relating to the amount of position history is satisfied (S23). More specifically, it is determined whether the amount of the history data of positions of the detected object is less than the amount of data required (used) for the determinations of the conditions based on position history (S20 to S22), that is, whether little time has elapsed since the detection of the object.

If it is determined that the condition relating to the amount of position history is satisfied (S23: YES), it is determined whether the condition relating to the speed of a pedestrian is satisfied (S24). More specifically, it is determined whether the speed of the detected object (pedestrian) in the vehicle traveling direction is lower than a threshold value (predetermined speed), that is, whether the detected object is not moving in the vehicle traveling direction.

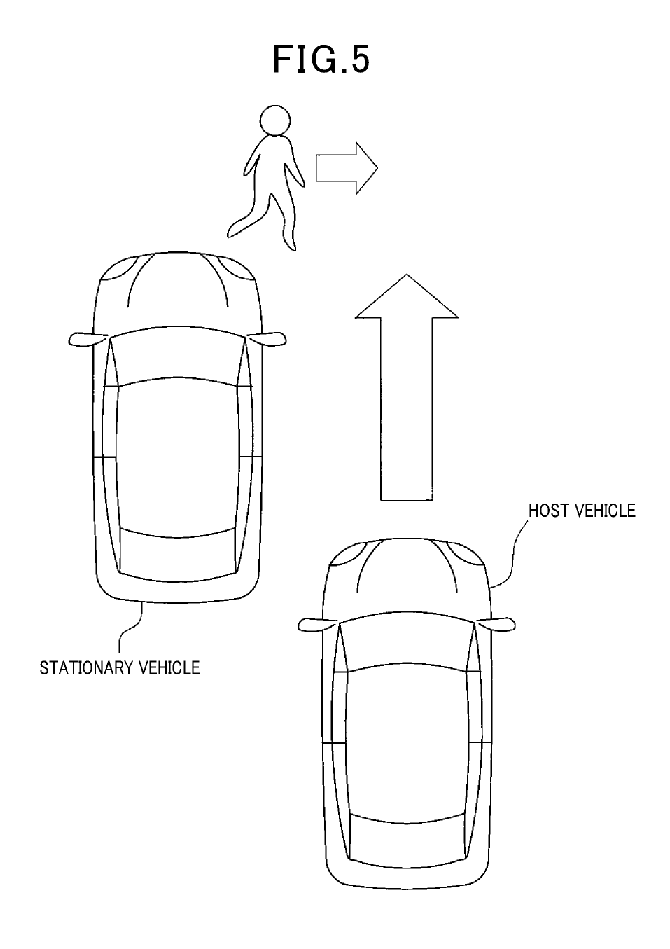

If it is determined that the condition relating to the speed of a pedestrian is satisfied (S24: YES), it is determined whether the condition for a hidden pedestrian is satisfied (S25). More specifically, it is determined whether the object (pedestrian) is a hidden pedestrian. For example, in a situation where there is a stationary vehicle (corresponding to a stationary object) in the traveling direction of the host vehicle as illustrated in FIG. 5, a pedestrian whose body is at least partially hidden behind the stationary vehicle or a pedestrian who appears from behind the stationary vehicle is regarded as a hidden pedestrian. In other words, a hidden pedestrian is a pedestrian on the further side of the stationary vehicle or a pedestrian who appears from the further side of the stationary vehicle.

If it is determined that the condition for a hidden pedestrian is satisfied (S25: YES), it is determined whether the condition relating to host vehicle speed is satisfied (S26). More specifically, it is determined whether the speed of the host vehicle is higher than a threshold value (predetermined speed). This threshold value is a value that makes it difficult for the driver to avoid a collision with a pedestrian emerging rapidly from behind a stationary vehicle.

If it is determined that the condition relating to host vehicle speed is satisfied (S26: YES), it is determined whether the condition for the straight-ahead traveling of the host vehicle is satisfied (S27). More specifically, it is determined whether the host vehicle is traveling in a straight line, that is, whether the host vehicle is not turning, on the basis of a detection value provided by the yaw rate sensor 33.

If it is determined that the condition for the straight-ahead traveling of the host vehicle is satisfied (S27: YES), steps S28 to 34 are executed. Specifically, if all the conditions in S13 to S19 and S23 to S27 are satisfied (if the probability of a collision is higher than a predetermined value), an automatic braking execution command is created on the basis of the collision time TTC as in the case above.

In contrast, if it is determined that any of the conditions in steps S23 to S27 is not satisfied, an automatic braking execution command is not created (S35).

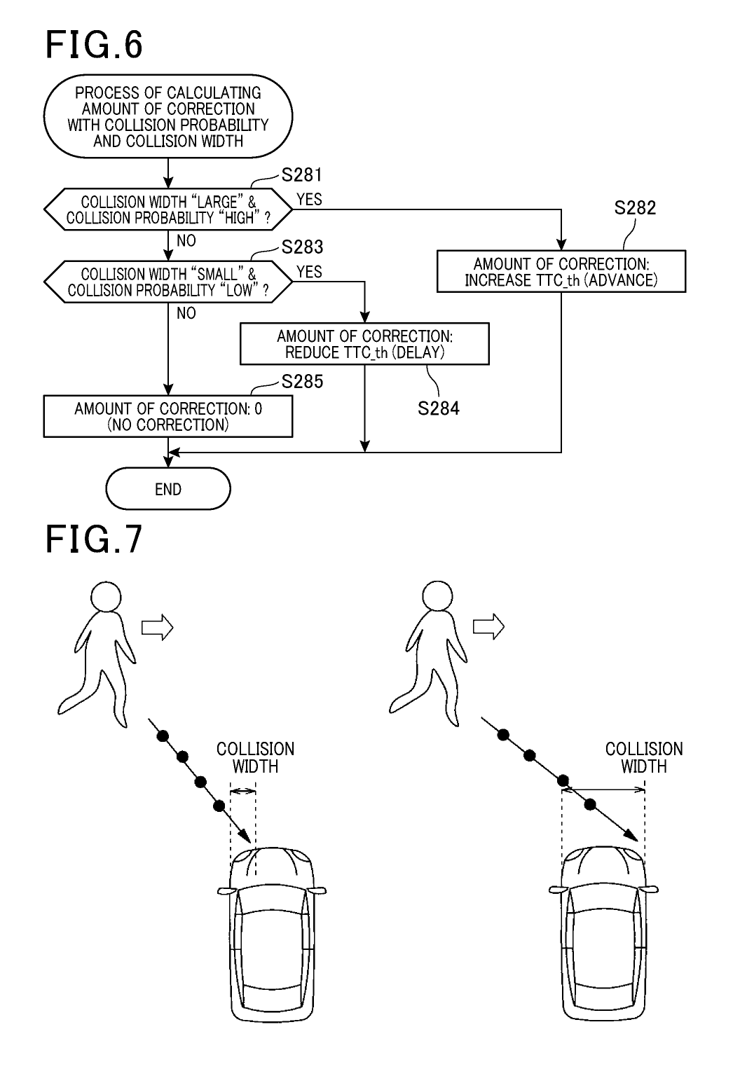

In S28, the amount of correction with collision probability and collision width is calculated (S28). In this step, as illustrated in FIG. 6, first, the collision width is compared with a reference width that is a reference value, and the collision probability is compared with a reference probability (reference rate) that is a reference value (S281 and S283).

As used herein, the collision width represents the distance from the width-directional edge of the host vehicle closer to a pedestrian to the collision position as seen from the width-directional center of the host vehicle as illustrated in FIG. 7, for example. Specifically, in a case where a pedestrian crosses in front of the host vehicle from the left side, collision widths are smaller at collision positions closer to the left (closer to the pedestrian) (refer to the left figure) and larger at collision positions closer to the right (further from the pedestrian) (refer to the right figure).

The reference width to be compared with the collision width is freely set, for example, in the center of the vehicle. The value obtained in the above-mentioned step is utilized as the collision probability, and the reference probability to be compared with the collision probability is freely set, for example, around 50%.

If the collision width is equal to or greater than the reference width and the collision probability is equal to or greater than the reference probability (S281: YES), the amount of correction is set to a value (e.g., +0.5 seconds) that increases an execution reference time TTC_th (S282), and the process of calculating the amount of correction with collision probability and collision width is finished.

As used herein, the execution reference time TTC_th is a threshold value for determining the timing of executing the host vehicle's control for avoiding a collision with an object. The timing of starting the control for avoiding a collision is delayed as the execution reference time TTC_th is reduced, and the timing of starting the control for avoiding a collision is advanced as the execution reference time TTC_th is increased.

If the collision width is less than the reference width and the collision probability is less than the reference probability (S281: NO and S283: YES), a value (e.g., −0.5 seconds) that reduces the execution reference time TTC_th is set (S284), and the process of calculating the amount of correction with collision probability and collision width is finished.

If the collision width is equal to or greater than the reference width and the collision probability is less than the reference probability, or if the collision width is less than the reference width and the collision probability is equal to or greater than the reference probability (S281: NO and S283: NO), the amount of correction is set to zero (S285), and the process of calculating the amount of correction with collision probability and collision width is finished.

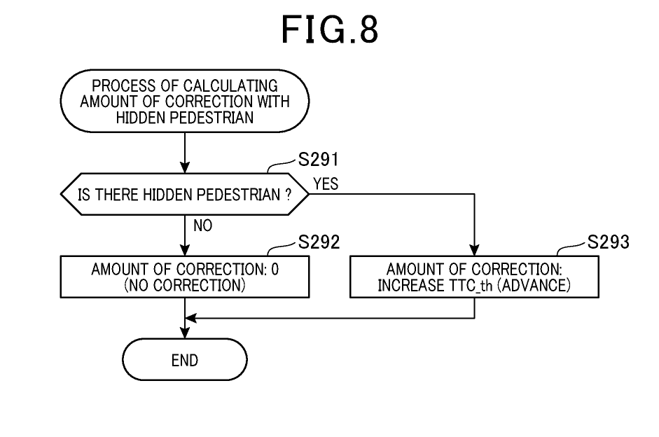

Returning to FIG. 2, next, the amount of correction with a hidden pedestrian is calculated (S29). In this step, as illustrated in FIG. 8, first, the presence or absence of a hidden pedestrian is determined (S291). If it is determined that there is no hidden pedestrian (S291: NO), the amount of correction is set to zero (S292), and the process of calculating the amount of correction with a hidden pedestrian is finished. If it is determined that there is a hidden pedestrian (S291: YES), the amount of correction is set to a value (e.g., +0.5 seconds) that increases the execution reference time TTC_th (S293), and the process of calculating the amount of correction with a hidden pedestrian is finished.

Returning to FIG. 2, next, the execution reference time TTC_th is calculated (S30). More specifically, the execution reference time TTC_th can be freely set, for example, at the threshold timing for enabling collision avoidance when the driver performs the operation of avoiding a collision at that point.

Next, the execution reference time TTC_th is corrected with each amount of correction (S31). In this step, a new execution reference time TTC_th is obtained by adding the amount of correction with collision probability and collision width and the amount of correction with a hidden pedestrian to the execution reference time TTC_th set in step S30.

Then, the collision time TTC representing the time left before the host vehicle collides with the object is computed on the basis of the relative velocity between the host vehicle and the object (S32). Next, it is determined whether the collision time TTC is shorter than the execution reference time TTC_th (S33).

If it is determined that the collision time TTC is shorter than the execution reference time TTC_th (S33: YES), an automatic braking execution command for causing the brake to execute collision mitigation operation is created (that is, a flag is set in the RAM 13) (S34). The automatic braking execution command includes not only the operation of activating the brake to actually reduce the speed of the vehicle but also preliminary operation (what is called brake prefill/pre-brake operation) for reducing the speed of the vehicle by the brake.

In contrast, if it is determined that the collision time TTC is not shorter than the execution reference time TTC_th (S33: NO), an automatic braking execution command is not created (that is, a flag is reset in the RAM 13) (S35).

Then, an execution control process is executed (S36). In the execution control process, on the basis of the created execution command (flag), the execution command is transmitted to the control target 40 (if there is a plurality of control targets 40, transmitted to each of the plurality of control targets 40). After that, the series of steps is temporarily finished (END).

Note that steps S13 to S22 correspond to a process as a determination unit, steps S28 to S36 correspond to a process as an execution unit, and steps S23 to S27 correspond to a process as a condition changing unit. If all the conditions in S23 to S27 are satisfied, steps S20 to S22 correspond to a process as a condition changing unit.

The present embodiment described in detail above has the following advantages.

In a case where it is determined that a detected object is a pedestrian emerging rapidly from behind a stationary vehicle (S23 to S25 in FIG. 2), the condition changing process is executed for making a change such that the probability of a collision is determined independently of the history of positions of the detected object (S26 to S27). Consequently, the need to use the history of positions of the object is fundamentally eliminated, and thus the probability of a collision between the vehicle and the object can be determined rapidly. As a result, the vehicle's collision mitigation operation against sudden appearance of the pedestrian can be executed early. Under normal conditions, the probability of a collision between the vehicle and the object is determined on the basis of the position of the object and the history of positions of the object (S13 to S22), so that unnecessary execution of collision mitigation operation can be prevented.

If the vehicle is traveling at low speed while a pedestrian is suddenly emerging, the vehicle has enough time to avoid colliding with the pedestrian. In such a case, early execution of the vehicle's collision mitigation operation could result in unnecessary execution of collision mitigation operation. In this regard, the condition changing process is executed on condition that the speed of the vehicle be higher than the threshold value (S26). Therefore, if the speed of the vehicle is not higher than the threshold value, the condition changing process is not executed even when a pedestrian is emerging. Thus, unnecessary execution of collision mitigation operation can be prevented.

If the vehicle is turning while a pedestrian is suddenly emerging, the driver is possibly performing the operation of avoiding the pedestrian. In such a case, early execution of the vehicle's collision mitigation operation could result in unnecessary execution of collision mitigation operation. In this regard, the condition changing process is executed on condition that the vehicle be traveling in a straight line (S27). Therefore, if the vehicle is not traveling in a straight line, the condition changing process is not executed even when a pedestrian is emerging. Thus, unnecessary execution of collision mitigation operation can be prevented.

The condition changing process is executed (S23) on condition that the amount of the history data of positions of the object detected by the radar sensor 32 and the camera sensor 31 be less than the amount of the history data used for the determination of the probability of a collision based on position history (S20 to S22). Therefore, if the amount of the history data of positions of the object detected by the detection device is equal to or greater than the amount of the history data used for the determination by the determination unit, the condition changing process is not executed even when a pedestrian is emerging, and the normal determination of the probability of a collision (S20 to S22) is executed. Thus, unnecessary execution of collision mitigation operation can be prevented.

If a pedestrian is present near a stationary vehicle but moving in the traveling direction of the vehicle, the pedestrian is possibly not suddenly emerging from behind the stationary vehicle. In such a case, early execution of the vehicle's collision mitigation operation could result in unnecessary execution of collision mitigation operation. In this regard, the condition changing process is executed on condition that the speed of the detected object in the vehicle traveling direction be lower than the threshold value (S24). Therefore, while the pedestrian is moving in the traveling direction of the vehicle, the condition changing process is not executed. Thus, unnecessary execution of collision mitigation operation can be prevented.

A situation where a pedestrian is suddenly emerging from behind a stationary vehicle is likely to occur when the pedestrian is at least partially hidden behind the stationary vehicle. In this regard, the condition changing process is executed on condition that the detected object be at least partially hidden behind the stationary vehicle or that the detected object appears from behind the stationary vehicle (S25). Therefore, if the object is not hidden behind the stationary vehicle at least partially, the condition changing process is not executed. Thus, unnecessary execution of collision mitigation operation can be prevented.

During the execution of the condition changing process (S23 to S27), once the amount of the history data of positions of the detected object becomes equal to or greater than the amount of the history data used for the determination of the probability of a collision based on position history, the condition changing process is finished (S20 to S22). Therefore, execution can be switched from the condition changing process to the normal determination of the probability of a collision once the normal determination of the probability of a collision is enabled. Thus, unnecessary execution of collision mitigation operation can be prevented.

Note that the above embodiment can be changed and implemented in the following manner. Components identical to those of the above embodiment are denoted by the same reference signs and thus not further described.

As a process of the condition changing unit, if all the conditions in S23 to S27 are satisfied, steps S20 to S22 may be executed after reducing the amount of position history required for the determinations (used for the determinations) in S20 to S22. With such a configuration, the probability of a collision is determined using a smaller amount of position history than before the change in condition, which can reduce the time required for completion of the determination. As a result, the vehicle's collision mitigation operation against sudden appearance of the pedestrian can be executed early.

Some of steps S23 to S25 as the determinations of sudden emergence may be skipped. Steps S26 and S27 may be skipped.

Some of steps S13 to S19 as the determinations without using position history may be skipped. Some of steps S20 to S22 as the determinations based on position history may be skipped.

Steps SS28, S29, and S31 may be skipped.

Hidden pedestrians are not necessarily pedestrians who appear from behind stationary vehicles, but may include pedestrians who appear from behind stationary objects such as buildings and roadside trees.

Bicycles may be targeted for determination instead of pedestrians.

A monocular camera may be employed as the camera sensor 31. In this case, the distance to an object is calculated on the basis of processing for an image captured by the monocular camera. In some possible configurations, only one of the radar sensor 32 and the camera sensor 31 may be provided. Such configurations can be implemented simply by skipping the determinations based on the FSN position.

The present disclosure has been described with reference to examples, but it is to be understood that the present disclosure is not limited to the examples and structures. The present disclosure covers various modifications and equivalent variations. In addition to various combinations and forms, other combinations and forms including one or more/less elements thereof are also within the spirit and scope of the present disclosure.

1. A collision mitigation control device that is applied to a vehicle including a detection device that detects a position of an object located ahead of the vehicle and a collision mitigation device that executes collision mitigation operation for the vehicle and the object, the collision mitigation control device being configured to control the collision mitigation operation of the collision mitigation device, the collision mitigation control device comprising:
a determination unit that determines a probability of a collision between the vehicle and the object on the basis of the position of the object detected by the detection device and a history of positions of the object;
an execution unit that causes the collision mitigation device to execute the collision mitigation operation in response to the determination unit determining that the probability of a collision is higher than a predetermined value; and
a condition changing unit that executes, in response to determining that the object detected by the detection device is a pedestrian or bicycle emerging rapidly from behind a stationary object, a condition changing process for making a change such that the determination unit determines the probability of a collision without using the history of positions of the object detected by the detection device.

2. A collision mitigation control device that is applied to a vehicle including a detection device that detects a position of an object located ahead of the vehicle and a collision mitigation device that executes collision mitigation operation for the vehicle and the object, the collision mitigation control device being configured to control the collision mitigation operation of the collision mitigation device, the collision mitigation control device comprising:
a determination unit that determines a probability of a collision between the vehicle and the object on the basis of the position of the object detected by the detection device and a history of positions of the object;
an execution unit that causes the collision mitigation device to execute the collision mitigation operation in response to the determination unit determining that the probability of a collision is higher than a predetermined value; and
a condition changing unit that executes, in response to determining that the object detected by the detection device is a pedestrian or bicycle emerging rapidly from behind a stationary object, a condition changing process for reducing an amount of history data used for the determination by the determination unit.

3. The collision mitigation control device according to claim 1, wherein
the condition changing unit executes the condition changing process on condition that a speed of the vehicle is higher than a predetermined speed.

4. The collision mitigation control device according to claim 1, wherein
the condition changing unit executes the condition changing process on condition that the vehicle is traveling in a straight line.

5. The collision mitigation control device according to claim 1, wherein
the condition changing unit executes the condition changing process on condition that an amount of history data of positions of the object detected by the detection device is less than an amount of history data used for the determination by the determination unit.

6. The collision mitigation control device according to claim 1, wherein
the condition changing unit executes the condition changing process on condition that a speed of the object detected by the detection device in a vehicle traveling direction is lower than a predetermined speed.

7. The collision mitigation control device according to claim 1, wherein
the condition changing unit executes the condition changing process on condition that the object detected by the detection device is at least partially hidden behind the stationary object or that the object detected by the detection device appears from behind the stationary object.

8. The collision mitigation control device according to claim 1, wherein
the condition changing unit finishes the condition changing process once an amount of history data of positions of the object detected by the detection device becomes equal to or greater than an amount of history data of positions of the object used for the determination by the determination unit.
